(19) United States
(12) Patent Application Publication
(10) Pub. No.: US 2002/0188576 A1
(43) Pub. Date: Dec. 12, 2002

(54) Pricing method and program product for usage based service

(76) Inventors: Eric Peterson, Fort Collins, CO (US); Pierre Perinet, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/854,835

(22) Filed: May 14, 2001

(51) Int. Cl. G06F 17/60

(52) U.S. Cl. 705/400; 705/1

(57) ABSTRACT

A method for determining a price for a usage based service session such as an on-line network service or telephone service has general steps of dividing a potential usage period into a plurality of tiers, and assigning an incremental charge and a usage rate to the tier. Usage charges for each tier can be determined by multiplying the usage rate for the tier by the amount of usage in the tier. A total price for the session can then be calculated by totaling the incremental charges for each tier entered during the session with the usage charges for each tier. Tier usage rates and incremental charges may comprise zero or negative numbers to provide flexibility in pricing a usage session.

### FIELD OF THE INVENTION

The present invention is directed to methods and systems for pricing usage based services. More particularly, the present invention is directed to methods and systems for pricing of a session of computer network service usage and the like.

### BACKGROUND OF THE INVENTION

The market for usage-based services has expanded greatly in the recent past. In particular, the “information age” has introduced a wide variety of on-line network services. Professionals in the legal, financial, and medical professions, by way of example, are regular consumers of on-line information network services. Business to business service models provide for on-line access to computing centers, call centers, and the like. Through so-called “utility computing”, for example, companies can pay for on-line access to advanced computer resources that may be required from time to time.

Additionally, the ubiquitous presence of the internet in the present day in the form of the World Wide Web has brought on-line network services to retail consumers. The near term future promises to expand the presence of such services as widespread and relatively low cost broad-band access promises a wider variety of information available on-line, such as on demand movies, gaming, music, and the like.

These services are priced in a variety of manners. Some services are available on a usage basis, with users paying for use on a per time basis, such as per minute. Other pricing models include flat rate subscription models, such as a per-session, per month, or a per-year pricing model. Still other pricing models are so-called hybrid models that combine elements of flat-rate and usage based models. In addition to time unit basis, services may be priced on other usages as well, such as a per printed page of output, per byte of downloaded information, per song downloaded, and the like.

While many pricing models for usage based services are known, there are many as yet unresolved problems in the art. For example, flat rate models and per usage models may be too simple to optimize revenue for many providers. There is increasing pressure to price services such that users “pay for what they use”, which is often not possible using current pricing models. By way of example, flat rate models have proven to be susceptible to extreme over use by a small percentage of subscribers, thereby increasing costs for providers. Per usage pricing models are strained by users with high-speed access that can download much more information in much less time than previously possible. Hybrid plans, on the other hand, while providing some degree of flexibility, are often so complicated to implement as to be impractical.

There is therefore an as yet unresolved need in the art for effective service pricing models.

### SUMMARY OF THE INVENTION

The present invention is directed to a method for pricing a usage based service, and generally comprises the steps of dividing a potential usage period into a plurality of tiers, determining the cost for each of the tiers entered during a usage session, and totaling these costs for a total session cost. There are two costs associated with each tier: an incremental cost charged when the tier is entered, and a tier usage based cost that is calculated by multiplying the amount of usage that occurs in the tier by a tier usage rate. The tiers are preferably characterized with a beginning threshold usage that defines where the tier begins, and a tier duration usage that defines the length of the tier. Preferably, the first tier has a beginning threshold of zero units of usage, and the last tier extends to infinite units of usage. With these preferred bounds, the method of the invention can be used for pricing any amount of usage.

The method of the invention provides for important advantages in terms of flexibility and ease of application. By adjusting incremental charges and usage rates, the method of the invention may in practice function as anything from a pure fixed cost pricing model, a pure usage based pricing model, a hybrid pricing model, and almost any variant in between. Preferably, the invention may be practiced with negative tier usage rates and tier incremental charges as desired to provide a pricing model capable of encouraging users to cross over into more profitable tiers, thereby providing a valuable tool for maximizing revenue. Additionally, the method of the invention achieves this wide range of flexibility in a relatively simple and easily applied format that is advantageous for cost and ease of use considerations.

Those knowledgeable in the art will appreciate that the method of the present invention lends itself well to practice in the form of a computer program product. Accordingly, an additional embodiment of the present invention comprises a computer program product for causing a computer to determine a price for a session of a usage based service.

The above brief description sets forth in a broad fashion several of the more important features of the present disclosure so that the detailed description that follows may be better understood, and so that the present contributions to the art may be better appreciated. There are, of course, additional features of the disclosure that will be described hereinafter. In this respect, before explaining an embodiment of the disclosure in detail, it is to be understood that the disclosure is not limited in its application to the details as set forth in the following description or illustrated in the drawings. The present invention is capable of other embodiments, as will be appreciated by those skilled in the art. Also, it is to be understood that the phraseology and terminology employed herein are for description and not limitation.

### BRIEF DESCRIPTION OF THE FIGURES

FIG. 1 is a graph helpful in illustration of an embodiment of the invention.

FIGS. 2(a)-(c) are a flow chart illustrating an embodiment of the invention.

### DETAILED DESCRIPTION

The method and program product of the invention generally comprise calculating a total usage session cost by totaling the charges for each tier entered during the session. The charges associated with each tier comprise an incremental cost charged for entering the tier, and a tier usage cost calculated by multiplying the amount of usage in a tier by the tier's usage rate.

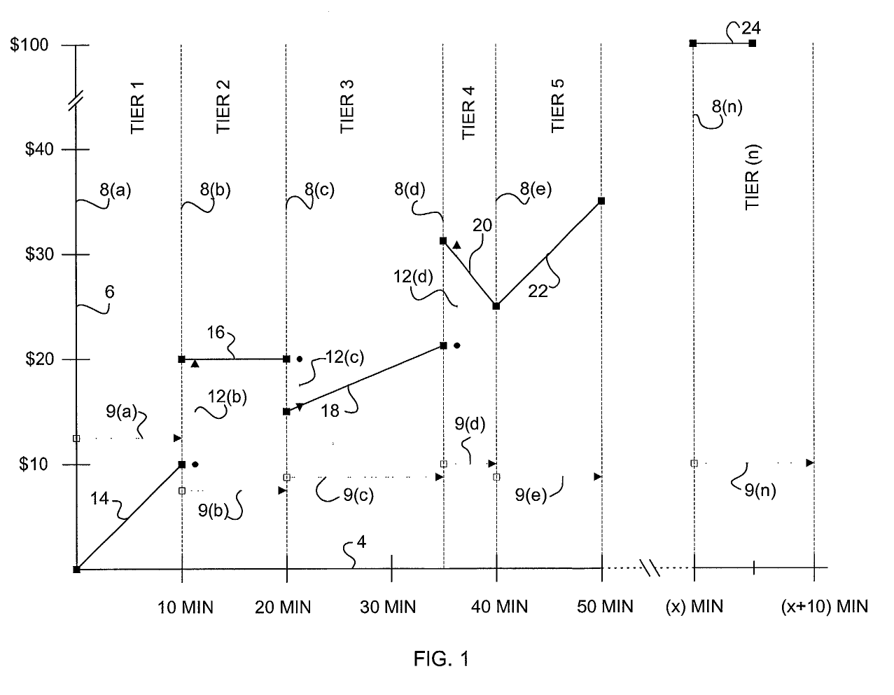

Turning now to the drawings, FIG. 1 is a chart useful in illustrating an embodiment of a method and computer program product of the invention. In general, this embodiment of the invention comprises dividing a potential on-line usage service session into n tiers as shown. A total of n tiers have been illustrated to point out that the method and program product of the invention are not limited to any particular number of tiers, so long as a plurality of tiers are comprised. It is anticipated that a preferred number of up to four tiers will be useful for practice of an embodiment of the invention useful for pricing of consumer internet service providers.

As illustrated by the chart of FIG. 1, the tiers proceed along the X-axis 4 that has usage units of time. The Y-axis 6 has units of cost, which are preferably dollar amounts as illustrated in FIG. 1. It will be appreciated that many additional units of usage and cost could be comprised within the scope of the present invention. By way of example, it is anticipated that online computer services may increasingly charge for usage in units of processor consumption or information downloaded, with possible usage units thereby comprising bits, bytes, pages, documents, processor use time, songs, movies, or the like. It will additionally be appreciated that cost may be measured in a wide variety of units other than money.

Each tier is characterized by a beginning threshold value illustrated in FIG. 1 by dashed vertical lines 8(a)-8(n), and a tier duration illustrated by dashed horizontal line segments 9(a)-9(n), which comprises the distance along the X-axis the tier extends. Each tier also has an endpoint that is equal to the beginning threshold plus the duration. By way of example, tier 3 has a beginning threshold value 8(b) of 10 min., a duration 9(c) of 10 min., and an endpoint at 20 min. Preferably the first tier has a beginning threshold value 8(a) (coincident with the Y-axis) of 0 min, and a final tier(n) extends to infinite usage. With these preferred bounds, this embodiment of the pricing method and computer program product of the invention can be used to fit any potential on-line session.

It is noted that a tier duration may extend a tier to the threshold of the next tier. That is, one tier may end coincident with the beginning of a subsequent tier, or a tier duration may extend a tier to a usage amount just less than the beginning threshold of the subsequent tier. It will be understood that as used the tiers being “consecutive” with one another is intended to refer to a condition whereby any usage value along the axis falls within one of the plurality of tiers. Further, as used herein, the term “coincident”, the term “an endpoint coincident with a beginning threshold”, and the like will be understood to encompass a condition of an endpoint with a beginning threshold just greater than the end, as well as an endpoint that is equal to the next beginning threshold.

This embodiment of the invention also comprises assigning each tier 2 an incremental charge 12(a)-12(d) illustrated in FIG. 1 by a dashed vertical line. The incremental charge 12 can be thought of as a fixed fee associated with entry of a tier. Preferably, the incremental charge associated with the first tier is zero. The incremental charges 12 assigned to tiers other than the first tier are preferably not limited to amounts greater than zero, and thus may comprise any number, including zero or a negative number, as illustrated by FIG. 1 (see, e.g., the negative incremental charge 12(c) or the zero incremental charge of Tier(n)). Additional steps of the method and program product of the invention comprise assigning a tier usage rate to each tier. The tier usage rate is then multiplied by the usage amount that occurs within the tier to result in a usage cost for the tier. The preferred usage rate can comprise a positive, negative, or zero rate.

Table 1 summarizes the beginning threshold values 8, the incremental charges 12, the tier durations 9, and the usage rates for each tier as illustrated by the chart of FIG. 1:

TABLE 1

| | Beginning | | | |
|---|---|---|---|---|
| | Threshold | | Incremental | |
| | Value: | Tier Duration: | Charge: | Usage Rate: |
| TIER 1 | 0 min. | 10 min. | $0 | $1/min. |
| TIER 2 | 10 min. | 10 min. | $10 | $0/min. |
| TIER 3 | 20 min. | 15 min. | −$5 | $0.33/min. |
| TIER 4 | 35 min. | 5 min. | $10 | −$1/min. |
| TIER 5 | 40 min. | 10 min. | $0 | $1/min. |
| ........ | .......... | ......... | ......... | .......... |
| TIER (n) | (x) min. | 10 min. | $0 | $0/min. |

Once the total usage amount for a given session is determined, a cost for the session can be calculated by summing the incremental charges and the usage charges for each tier entered during the session.

With reference made to FIG. 1 and Table 1 simultaneously, this embodiment of the invention can be explained with reference to the hypothetical on-line session of Table 1 that lasts (x+5 min.). The session begins with entry to Tier 1, which has an incremental charge of $0. As the session proceeds through Tier 1, the Tier 1 usage rate charge of $1/min results in the total session cost increasing gradually as illustrated by line 14 to total $10 as Tier 1 ends after 10 min. As the session enters Tier 2 at the Tier 2 beginning threshold time 8(b) of 10 min., the incremental charge of $10 brings the total session cost to $20. As a result of the Tier 2 usage rate of $0/min., the total session cost remains at $20 as the session proceeds through Tier 2 as illustrated by the line segment 16.

The total session cost actually decreases as the session enters Tier 3 due to the Tier's incremental charge of −$5. It will be appreciated that zero or negative incremental charges may be advantageous to encourage users to enter into tiers that provide for a higher profit session. As the session proceeds through Tier 3, the session cost gradually increases as a function of the Tier's usage rate of $0.33/min. as illustrated by line segment 18. Tier 4 has a beginning threshold value 8(d) of 35 min. and an incremental cost of $10. The line segment 20 shows the total session cost decreases as it proceeds through Tier 4 due to the −$1/min. usage rate. Like negative incremental charges, it will be appreciated that zero or negative usage rates may be advantageous to encourage users to continue on with a session until their session has crossed over into a higher profit tier.

As the session crosses the 40 min. beginning threshold value 8(e) of Tier 5 an incremental charge of zero is incurred. The $1/min. usage rate of Tier 5 gradually increases the session cost as shown by line segment 22. The hypothetical session of FIG. 1 continues through an unidentified number of Tiers until the final Tier(n) is reached. Upon entering Tier(n) at the beginning threshold value 8(n) of (x) min., the session has a total cost of $100. Tier(n) has an incremental charge of $0 associated with it, and a usage rate of $0/min., so the total session cost remains at a constant $100 until the session is terminated at (x+5) min as shown by the line segment 24.

Through this embodiment of the invention it will be appreciated that the total session cost of the session illustrated through FIG. 1 could be determined by reference to the various line segments 14-24 at any point along the axis 4. Thus, the invention provides a pricing model for application to any potential usage amount. Additionally, it will be appreciated that the path of line segments 14-24 can be easily controlled as desired by adjusting the various tier beginning threshold values, incremental charges, and usage rates. The invention thereby provides a pricing model that is most useful for maximizing revenue.

Those knowledgeable in the art will appreciate that the invention lends itself well to practice in the form of a computer program product. In particular, an embodiment of the present invention comprises a computer program product comprising a computer usable medium having computer readable program code embodied in the medium that when executed causes a computer to carry out the various steps of the method of the invention. Preferred examples of computer usable mediums comprise magnetic and optical mediums such as disks, and circuitry such as printed or etched circuit cards and chips. Preferred examples of readable computer code comprise programmed instructions such as C++, Java and the like that has been compiled into a machine-readable format.

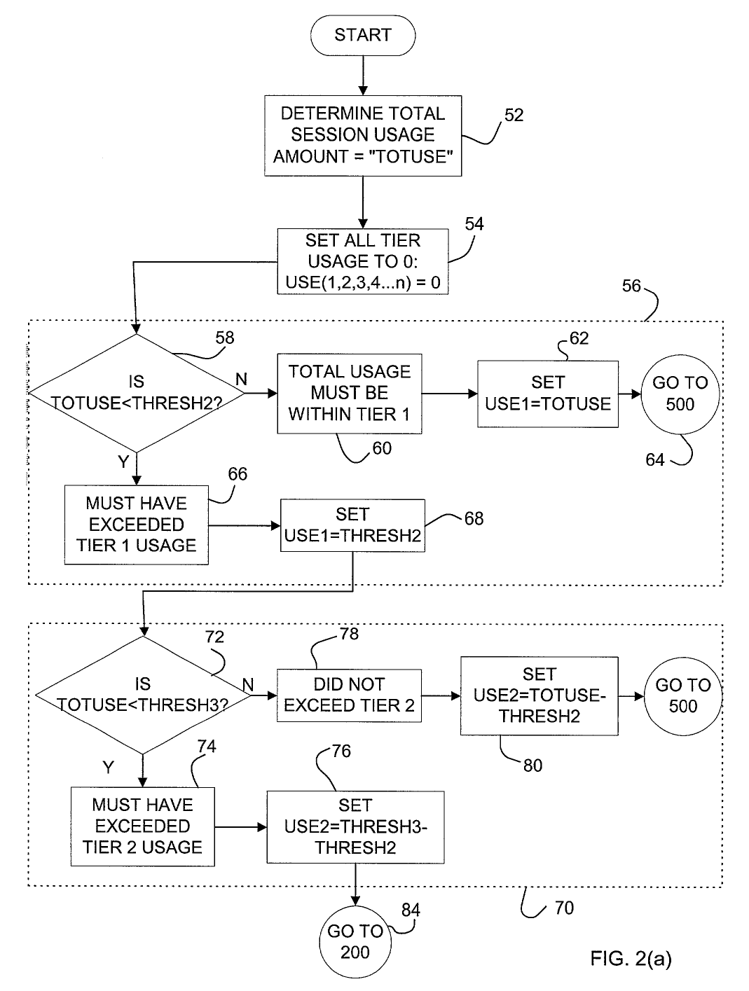

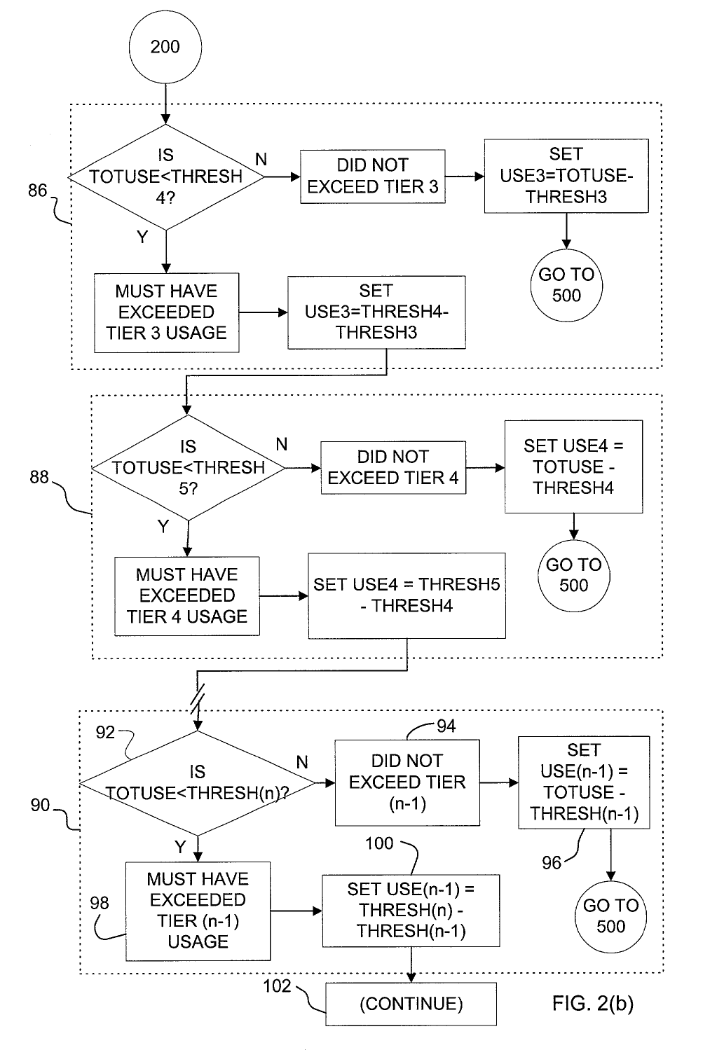

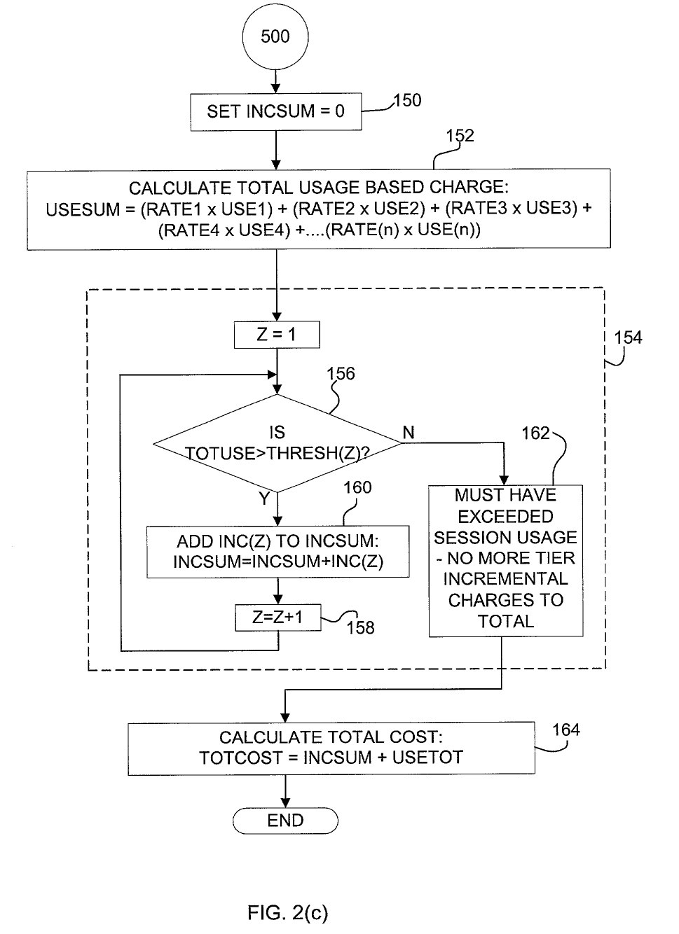

A preferred computer program product is illustrated through the flow chart of FIGS. 2(a)-(c). It will be appreciated that although this invention embodiment is referred to as a computer program product, it could likewise be practiced in the form of a method. With reference to the flow chart of FIGS. 2(a)-(c), a brief description of variables will be helpful as summarized in

TABLE 2

| Variable: | Description: |
|---|---|
| TOTUSE | Total Session Usage Amount |
| USE(1, 2, 3 . . . n) | Session Usage Amount occurring |
| | in each individual Tier(1-n) |
| THRESH(1, 2, 3, . . . n) | Beginning Threshold Value that |
| | marks the start of each individual |
| | Tier |
| RATE(1, 2, 3 . . . n) | Usage Rate for Each Individual |
| | Tier |
| USESUM | Sum Total of Individual Usage |
| | Charges for Each Tier |
| INC(1, 2, 3 . . . n) | Incremental Charge associated |
| | with entry to each individual Tier |
| INCSUM | Sum Total of Tier Incremental |
| | Charges |
| TOTCOST | Total Session Cost |

The program product of the invention when executed first causes the computer to determine the total session usage amount TOTUSE (block 52). Individual tier usage variables USE (1,2,3,. n) are also initially set to 0 (block 54).

The program product then causes the computer to progress through a number of subsets of steps that determine the tier usage values for each of the individual tiers(1) to (n). A first subset is illustrated within the dashed line box 56 of FIG. 2(a) and is for determining the tier usage amount USE1 for tier 1. The total usage amount is first compared to the beginning threshold value of tier 2 (block 58), if the total usage is less than the tier 2 threshold, then it is concluded that tier 1 was never exceeded during the session (block 60) and the tier 1 usage USE1 can be set equal to the total session usage amount (block 62) (assuming that tier 1 begins with the preferred beginning threshold of 0 usage). If this result is determined, there are no additional tier usage amounts to determine, and the program product causes the computer to continue on to a subset of steps for determining the total charges for the session (block 64).

If it were determined that the total session usage TOTUSE was greater than the Tier 2 beginning threshold value (block 58), then the program product causes the computer to conclude that tier 1 was exceeded during the session (block 66) and to set the amount of usage in tier 1 equal to the total duration of tier 1 (block 68). The program product further causes the computer to proceed to determine the total usage in tier 2.

The subset of steps for making this determination is illustrated within dashed line box 70 of FIG. 2(a). Within this subset, an initial determination is made as to whether the session total usage time exceeds the beginning threshold time for the subsequent tier 3 (block 72). If so, tier 2 must have been exceeded during the session (block 74), and tier 2 usage time is set equal to the duration of tier 2 (block 76). It is noted that FIG. 2(a) illustrates the tier duration being determined by the difference between beginning thresholds. This could of course also be determined, by way of example, by using the known tier duration.

The program product then causes the computer to proceed on to determine total tier use for tier 3 (block 84). If the session total usage does not exceed the beginning threshold of the next tier, then tier 2 was not exceeded during the session (block 78). If so, the tier usage time for tier 2 is set equal to the total usage time less the beginning threshold value for tier 2 (block 80), and the program product causes the computer to proceed on to a subset of steps for summing the total session cost (block 82).

With reference now drawn to FIG. 2(b), several subsets of steps shown in dashed line boxes 86, 88, and 90 that the computer program product of the invention causes the computer to take to determine the usage amount during the session in each of tiers 3, 4, and (n-1); respectively. It will be appreciated that these subsets of steps are essentially the same as those illustrated in dashed line box 70 describing the steps taken to determine the amount of usage that occurred in tier 2. Because these steps are essentially the same for all subsets, they will be described in detail with reference to only one of the subsets of FIG. 2(b). Those knowledgeable in the art will appreciate that the description provided will be applicable for not only all subsets illustrated in FIG. 2(b), but for any tier from tier 2 to tier n that may be comprised.

With reference to dashed line box 90, then, the computer program product first causes the computer to determine whether the total usage exceeds the beginning threshold of the subsequent tier (box 92). If not, the session did not enter the subsequent tier and must have ended in the current tier (n-1) (block 94). The tier (n-1) usage is accordingly set as the total usage less the beginning threshold of tier (n-1) (block 96), and the program product causes the computer to advance to cost calculation subset f steps (block 102). If the session total usage did exceed the beginning threshold of the subsequent tier, then the current tier must have been exceeded during the session (block 98), and the tier usage for the tier is accordingly set as equal to the duration of the tier, or the difference between the next beginning threshold and the current threshold (block 100).

Upon a determination that the total usage exceeds tier (n-1), the program product of the invention will cause the computer to continue determining tier usage amounts in subsequent tiers until a tier is reached that has not been exceeded during the session. This has been illustrated in FIG. 2(b) by a progression to a “continue” block 102.

When a tier is reached that the session total usage has not exceeded, the program product will direct the computer to a subset of steps for calculating the total session cost. This subset is illustrated in FIGS. 2(c). The total session cost comprises two components: a total usage cost, and a total incremental cost. Referring now to FIG. 2(c), the program product begins total cost calculation by causing the computer to set the incremental charge total to zero (block 150), and to calculate the total usage cost for the session, which generally comprises summing the usage charges for each tier (block 152). The usage charges for each of the tiers are calculated by multiplying the tier usage amount (TIER(1,2,3 . . . n)) previously determined by the tier usage rate (RATE(1,2,3 . . . n)). The computer program product of the invention may cause the computer to retrieve stored tier usage rates (RATE(1,2,3 . . . n)) for each tier from a depository where they have been stored after input by a user.

The incremental charge portion of the total session cost is calculated through steps illustrated within the dashed line box 154 of FIG. 2(c). Generally, these steps comprise summing the incremental charge for each tier entered during the session to a total sum incremental charge amount. As those knowledgeable in the art will appreciate, there are a number of ways to accomplish this. One preferred manner is through the steps illustrated within box 154 that generally comprises stepping through a loop. Each successive run through the loop examines a successive tier, starting at tier 1 (block 158). A decision is made at each step of the loop to determine whether the corresponding tier was entered during the session (block 156). If so, the incremental charge associated with that tier is added to the incremental charge sum for the session (block 160). If a respective tier was not entered during the session, it is determined that no subsequent tiers were entered and that there are no additional incremental charges to add to the incremental total (block 162).

When this occurs, the loop of box 154 is exited, and the program product causes the computer to calculate a total session cost by adding the total usage cost to the total incremental cost (block 164). It will be appreciated that although no additional steps are illustrated in FIG. 2(c), other embodiments of the computer program product of the invention may comprise causing the computer to execute additional steps regarding subsequent treatment of the total cost, such as displaying the cost, or otherwise transmitting, reporting, or storing the total cost.

Those knowledgeable in the art will likewise appreciate that the method and program product of the invention may be carried out in a wide variety of embodiments other than that illustrated and discussed herein that will fall within the spirit of the invention and the claims. By way of example, the sequence of many of the invention steps may be arbitrary, and may easily be altered without significant effect on the outcome of the invention. The tasks of determining tier usage amounts and tier usage costs could be accomplished in a single subset of steps, by way of example. Likewise, the format of many of the steps as illustrated is intended to be by way of example only. Many of the method and program steps could be accomplished in formats other than those illustrated within the scope of the invention as claimed.

It will be appreciated that the present invention thereby provides a solution to many otherwise unresolved problems in an efficient and novel manner. For example, a method for pricing a usage based service, such as network computer service, telephone service, or the like, is provided that may be easily applied to price any amount of usage, and to flexibly price usage so as to maximize revenue. The invention advantageously allows for combining elements of fixed price and usage based price models in a flexible and easily applied format.

The advantages of the disclosed invention are thus attained in an economical, practical, and facile manner. While preferred embodiments and example configurations have been shown and described, it is to be understood that various further modifications and additional configurations will be apparent to those skilled in the art. It is intended that the specific embodiments and configurations herein disclosed are illustrative of the preferred and best modes for practicing the invention, and should not be interpreted as limitations on the scope of the invention as defined by the appended claims.

What is claimed is:

1. A method for pricing a session of a usage based service comprising the steps of:
dividing a potential usage period into a plurality of tiers;
assigning a usage rate to each of said tiers;
assigning an incremental charge to each of said tiers;
determining a tier usage amount for each of said tiers for the session;
calculating a usage cost for each of said tiers by multiplying said tier usage amount by said usage rate for each respective of said tiers;
calculating a total usage cost by summing each of said tier usage costs;
calculating a total incremental cost by summing said incremental charges for each tier entered during the session; and,
pricing the session by summing said total usage cost and said total incremental cost.

2. A method as defined by claim 1 wherein each of said plurality of tiers is characterized by a beginning threshold usage value.

3. A method as defined by claim 1 wherein a first of said plurality of tiers has a threshold usage value of zero units.

4. A method as defined by claim 1 wherein a last of said plurality of tiers extends to infinite usage.

5. A method as defined by claim 1 wherein said plurality of tiers is consecutive with one another.

6. A method as defined by claim 1 wherein said plurality of tiers each being equal in usage duration.

7. A method as defined by claim 1 wherein said units comprise units chosen from the group consisting of time, information, and digital data.

8. A method as defined by claim 1 wherein at least one of said tier usage rates is negative.

9. A method as defined by claim 1 wherein at least one of said tier incremental charges is negative.

10. A method as defined by claim 1 wherein said plurality of tiers are characterized by a beginning threshold usage value and a tier duration usage value; wherein said plurality of tiers are consecutive with one another, and wherein said step of determining a tier usage amount for each of said tiers comprises the steps of:
determining a total session usage amount for the session;
determining which of said tiers have been entered during the session;
determining which of said tiers have been exceeded during the session;
determining a tier usage amount for each of said tiers entered during the session by setting said tier usage value equal to said tier duration value for each of said exceeded tiers, and subtracting said tier beginning threshold value from said total session usage amount for a tier that has been entered but not exceeded.

11. A method as defined by claim 10 wherein said step of determining whether a tier has been entered comprises:
determining that a respective of the plurality of tiers has been entered if said total session usage is greater than or equal to said beginning threshold usage value for said respective tier.

12. A method as defined by claim 10 wherein said step of determining whether a tier has been exceeded comprises:
determining that a respective tier has been exceeded if a subsequent tier has been entered during the session.

13. A method for pricing a session of a usage based service comprising the steps of:
dividing a potential usage period into a plurality of tiers, each of said tiers characterized by a beginning threshold usage value and a tier duration, each of said tiers having an endpoint at a usage amount equal to a sum of said threshold beginning usage value and said tier duration, said tiers being consecutive whereby said endpoint of a preceding tier is coincident with said beginning threshold usage value for a succeeding second tier, a first of said plurality of tiers having a beginning threshold value of zero units;
assigning a usage rate to each of said tiers, at least one of said usage rates being negative;
assigning an incremental charge to each of said tiers;
determining a total usage amount for the session;
determining that a respective tiers of the plurality of tiers has been entered if said total session usage is at least equal to said beginning threshold time for said respective tier;
determining that a respective tier has been exceeded if a subsequent tier has been entered during the session;
determining a tier usage amount for each of said tiers entered during the session by setting said tier usage value equal to said tier duration value for each of said exceeded tiers, and subtracting said tier beginning threshold value from said total session usage for a tier that has been entered but not exceeded;
calculating a usage cost for each of said tiers by multiplying said tier usage amount by said usage rate for each respective of said tiers;
calculating a total usage cost by summing each of said tier usage costs;
calculating a total incremental cost by summing said incremental charges for each tier entered during the session; and,
pricing the session by summing said total usage cost and said total incremental cost.

14. A computer program product for causing a computer to calculate a price for a session of a usage based service, the program product comprising a set of computer executable instructions embedded in a computer readable medium, the executable steps when executed causing the computer to:
divide a potential usage period into a plurality of tiers, each tier starting with a threshold usage value;
assign a per unit usage rate to each of said tiers;
assign an incremental charge to each of said tiers;
determine a usage value for each of said tiers for the session;
calculate a usage cost for each of said tiers by multiplying said usage value by said per unit usage rate for each respective of said tiers;
calculate a total usage cost by summing each of said usage costs for each of said tiers;
calculate a total incremental charge by summing each of said incremental charges for each tier entered during the session; and,
calculate the price for the session by summing said total usage cost and said total incremental charge.

15. A computer program product as defined by claim 14 wherein a first tier of said plurality of tiers has a threshold usage value of zero units, and a last of said plurality of tiers extends to infinite usage.

16. A computer program product as defined by claim 14 wherein said units are chosen from the group consisting of time and digital data.

17. A computer program product as defined by claim 14 wherein at least one of said usage rates is negative.

18. A computer program product as defined by claim 14 wherein at least one of said incremental costs is negative.

19. A computer program product for causing a computer to calculate a price for a session of an on-line service, the program product comprising a set of computer executable instructions embedded in a computer readable medium, the executable steps when executed causing the computer to:
divide a potential usage period into a plurality of tiers, each of said tiers characterized by a beginning threshold usage value, a duration usage, and a duration endpoint, said tiers being consecutive whereby a first tier having an endpoint coincident with the beginning of a second tier, a first of said plurality of tiers having a beginning threshold value of zero;
assign a usage rate to each of said tiers, at least one of said usage rates being negative;
assign an incremental charge to each of said tiers;
determine a total usage value for the session;
determine a tier usage value for each of said tiers entered during the session comprising the amount of usage value occurring between said beginning threshold value and said final duration value for said tier;
calculate a usage cost for each of said tiers by multiplying said tier usage value by said usage rate for each respective of said tiers;
calculate a total usage cost by summing each of said tier usage costs;
determine a respective of said tiers to have been entered during the session if said usage value is greater than said beginning threshold value for said respective tier;
calculate a total incremental cost by summing said incremental charges for each tier entered during the session; and,
calculate a price for the session by summing said total usage cost and said total incremental cost.

20. A computer program product for causing a computer to calculate a price for a session of an on-line service, the program product comprising a set of computer executable instructions embedded in a computer readable medium, the executable steps when executed causing the computer to:
determine the total on-line usage amount during the session;
create a plurality of consecutive tiers within a potential on-line usage amount, each of said tiers characterized by a beginning threshold usage amount and a tier duration usage;
compare the total on-line usage amount to said plurality of tier threshold times;
determine that a respective tier of the plurality of tiers has been entered during the session if said total on-line usage amount is greater than or equal to said beginning threshold usage amount for said respective tier;
determine that a respective tier has been exceeded during the session if a subsequent tier has been entered;
determine a tier usage amount for each of said plurality of tiers by setting said tier usage value equal to said tier duration usage for each of said exceeded tiers, and subtracting said tier beginning threshold usage amount from said total usage amount for a tier that has been entered but not exceeded;
determine a tier usage cost by multiplying said tier usage rate by said tier usage amount for each of said tiers;
calculate a total usage cost by summing each of said tier usage costs;
calculate a total incremental cost by summing said incremental charges for each of said entered tiers; and,
calculate a price for the session by summing said total usage cost and said total incremental cost.
